(19) United States
(12) Patent Application Publication
(10) Pub. No.: US 2025/0231390 A1
(43) Pub. Date: Jul. 17, 2025

(54) METHOD AND CONTROL DEVICE FOR ADJUSTING AND/OR CALIBRATING AND/OR MONITORING THE FOCUS VALUE OF AN OPTICAL DEVICE WITH A ZOOM FUNCTION

(71) Applicant: Carl Zeiss Meditec AG, Jena (DE)

(72) Inventors: Richard Baeumer, Urbach (DE); Marco Woerner, Gerstetten (DE); Christian Beder, Aalen (DE)

(21) Appl. No.: 19/171,005

(22) Filed: Apr. 4, 2025

Related U.S. Application Data
(63) Continuation of application No. PCT/EP2023/077214, filed on Oct. 2, 2023.

(30) Foreign Application Priority Data
Oct. 5, 2022 (DE) 10 2022 125 662.6

(51) Int. Cl. G02B 21/24; G02B 21/00; G02B 21/22

(52) U.S. Cl. CPC G02B 21/244; G02B 21/0012; G02B 21/006; G02B 21/22

(57) ABSTRACT

A method performs at least one of adjusting, calibrating and monitoring a focus value of a surgical microscope including at least one objective, an image capture device and a zoom system, wherein the surgical microscope is configured to be operated in at least two different zoom positions. The method provides for at least two different zoom positions, capturing at least one image of a specified object via the image capture device; via the at least one captured image, determining a plurality of contrast values depending on the focus value; and, via the determined contrast values for the at least two zoom positions, ascertaining at least one desired value for at least one of the following: i) at least one parameter for adjusting the focus value of the surgical microscope; and, ii) at least one parameter for calibrating the focus value of the surgical microscope.

### CROSS-REFERENCE TO RELATED APPLICATIONS

This application is a continuation application of international patent application PCT/EP2023/077214, filed Oct. 2, 2023, designating the United States and claiming priority from German application 10 2022 125 662.6, filed Oct. 5, 2022, and the entire content of both applications is incorporated herein by reference.

### TECHNICAL FIELD

The present disclosure relates to a method for adjusting and/or calibrating the focus value of a surgical microscope, to a control device for adjusting and/or calibrating the focus value of a surgical microscope, to a surgical microscope, to a computer-implemented method, to a computer program product, to a computer-readable data carrier, and to a data carrier signal. At least one specification heading is required.

### BACKGROUND

In the context of optical devices, adjusting and calibrating the focus usually plays an important role. Adjusting is understood to mean the one-time setting of the device, for example during service or assembly, and calibrating is understood to mean the adaptation of single or multiple parameters during service or assembly or operation of the device. In the context of calibrations, control curves can be stored, for example, which are applied later.

For the adjustment and calibration of video modules, so-called optical reference devices are usually used, which can be used in analog or digital form. These optical reference devices attempt to represent both the optical center of a main observer and the focal position of the main observer via a strict mechanical tolerance chain, for example a specified positioning of the optical unit with respect to a dovetail interface, on which an optical reference device is mounted. The main observer is already pre-adjusted. The main observer is thus used in combination with the optical reference device as a reference, in particular for a position in an image plane (x-y plane), the focus position, and the rotation. When adjusting the focus, it is usually intended that the focus values at which the contrast value is maximum differ only slightly or not at all at different zoom positions.

### SUMMARY

Against this background, an object of the present disclosure is to provide an advantageous method for adjusting and/or calibrating the focus value of a surgical microscope, an advantageous control device for calibrating the focus value of a surgical microscope, an advantageous surgical microscope, a computer-implemented method, a computer program product, a computer-readable data carrier, and a data carrier signal.

The method according to the disclosure for adjusting and/or calibrating and/or monitoring the focus value of a surgical microscope, which includes at least one objective, an image capture device, for example in the form of a camera chip, and a zoom system, wherein the optical device is configured to be operated in at least two different zoom positions, that is, zoom positions that deviate from one another, includes the following steps: if there are at least two different zoom positions, at least one image, that is, one image representation, of a specified object is captured by the image capture device. Subsequently, a plurality of contrast values are determined depending on the focus value via at least one captured image. At least one respective contrast value can be determined in a plurality of images which are captured at respectively different focus values. However, a plurality of contrast values can also be determined in one captured image. This is useful for an image of a tilted object.

The focus value can be a relative focus value or a focus value difference. Usually, a focus value which depends only on the position of the optical elements of the main objective is output by the surgical microscope. In this case, a flat or planar calibration object positioned perpendicular to the optical axis can be used. In the case of surgical microscopes with a constant focal length, the use of a flat calibration object tilted relative to the optical axis is advantageous. For example, a relative focus value in the form of a change in focus or a migration of focus depending on the zoom setting can be determined, for example, calculated. The terms zoom position and zoom setting are used synonymously in this description.

The contrast values can preferably be determined by image evaluation. The image evaluation can be carried out digitally and/or automatically and/or visually. Specified image points or image segments or image sections can be evaluated here. In a further step, at least one desired value for at least one parameter for adjusting and/or calibrating the focus value of the surgical microscope is determined via the determined contrast values for the at least two zoom positions. For this purpose, the focus value at which the contrast value for the respective zoom position is maximum can be ascertained. A parameter for adjusting and/or calibrating the focus value of the surgical microscope is understood to mean a variable which can be changed in the adjustment and/or calibration of the focus value, for example the distance between the at least one objective and the image capture device or the distance between individual lenses or lens groups of the objective.

Depending on the requirements to be met, the method can be carried out for all zoom positions or only for a plurality of selected zoom positions.

The ascertainment of the desired value can include the ascertainment of a change value of the focus, in particular a zoom-independent focus position, of the surgical microscope. The ascertainment of the desired value, in particular the change value, can be based on an evaluation of the gradient of at least one curve, for example, a straight line, which maps the dependence of the focus value or a detected focus change in relation to a reference variable on the zoom position. The focus change can be specified, for example, in relation to the position of a zoom center or another specified object-side reference point, for example, an object marking on the object (calibration object). The focus change can be specified in any units that can be defined, for example, by elements imaged onto the object.

A functional relationship, for example, a linear dependence, between the gradient and the focus position or focus setting of the surgical microscope can be assumed or ascertained by appropriate measurements. From the functional relationship, for example, the gradient of a corresponding straight line, the desired value and/or the change value can be calculated directly via the contrast values ascertained for at least two different zoom positions or the resulting absolute or relative focus values for which the contrast is maximum. The desired value can be calculated and/or provided and/or displayed and/or monitored in the form of a target focus line or target focus region in a captured image of the specified object, for example, for a specific zoom setting. This allows a technician to adjust and/or calibrate accordingly. Adjustment and/or calibration can be performed at a preset or at any zoom setting.

The image capture device can be a camera, such as a video camera. It may include a camera chip. The surgical microscope may have a stereoscopic optical system.

The present disclosure has the advantage that a surgical microscope with a mechanical zoom system can be set in focus independently of a main observer and an optical reference device. An optical reference device is therefore not necessary for adjusting and/or calibrating the focus. The deviation from an ideal device, which is tuned to infinity, that is, is pre-adjusted so that, when an object is in focus, the optical beams in the magnification system are parallel, can be quantified, for example, by the deviations of the focus values at which the contrast value is maximum. The focus setting is also independent of a main observer and therefore independent of the observer's absence or subjective evaluation. A further advantage is that the use of a measured calibration object can be dispensed with, since only relative focus values can be used for adjustment and/or calibration.

In a preferred variant, the surgical microscope includes at least one first objective, for example in the form of a main objective, and a second objective, for example in the form of a video objective, wherein the second objective is arranged in the beam path between the first objective and the image capture device.

In an advantageous variant, at least one correction value for the relative position of the at least one objective, for example, the second objective and/or the first objective, and/or the image capture device within the surgical microscope with respect to the beam path can be ascertained based on the at least one desired value.

The at least one desired value can be ascertained and/or specified separately for each of the at least two zoom positions. The at least one desired value can be ascertained and/or specified for the at least two zoom positions in such a way that the difference between the focus values at which the contrast value is maximum is less for the at least two zoom positions than a specified threshold value. This has the advantage that when the zoom position is changed, the focus value changes only slightly or the focus value does not change if the difference is zero.

For example, based on the ascertained focus value at which the contrast value for the respective zoom setting is maximum, at least one desired value for at least one parameter for adjusting and/or calibrating the focus value of the surgical microscope can be ascertained and/or specified. As part of the adjustment, the second objective, that is, the video objective, for example, is preferably displaced such that a corresponding desired value for the positioning and/or displacement can be ascertained and/or specified. The at least one desired value for each of the at least two zoom positions can be ascertained and/or specified in one of the two zoom positions or in a further zoom position. If a check reveals that the surgical microscope is correctly adjusted, the desired value will be equal to the actual value or within a tolerance range. This also enables monitoring or remote monitoring of the surgical microscope.

In an advantageous variant, at least one image of a planar surface of the specified object can be captured, wherein the planar surface has a surface normal which encloses with the optical axis of the objective an angle of between 0 degrees and 90 degrees, in particular an angle of between 5 degrees and 85 degrees, for example 20 degrees. In other words, in the above examples, the planar surface encloses with the optical axis of the objective an angle of between 90 degrees and 0 degrees, in particular between 85 degrees and 5 degrees, for example 70 degrees. The use of a planar surface has the advantage that the distance of an object point from the objective is easy to ascertain, and thus the image evaluation is simplified.

Preferably, the object used is a known calibration object. It can have a specified pattern, for example a checkerboard pattern. Therefore, advantageously in each case at the at least two different zoom positions at least one image of a specified calibration object is captured, which has known features, so that high-contrast regions are recognizable in the image representation. If the geometry of the calibration object is known, high-contrast regions in the image can be predicted. These can be determined and evaluated in terms of contrast. This reduces the computing time. For example, the calibration object may be a ChArUco board. The stated variants simplify the determination of the contrast values and provide a robust solution to errors due to possible noise. For example, only contrast values within a specified region of the center of the image may be determined and/or evaluated. This simplifies and accelerates the adjustment and/or calibration.

Advantageously, the dimensions of the pattern, in particular the dimensions of elements of the pattern, are known or preset, or the dimensions are determined. The dimensions can be known or preset or determined in a unit of length, for example, millimeters. Preferably, the imaging scale, for example, in the form of a relationship between the respective dimension of at least one element of the calibration object, for example, in millimeters, and in a unit of length of the camera chip, for example, in pixels, is known or preset or is determined. If the tilt of the calibration object is known or preset or set in a defined manner or ascertained, the focus value can be ascertained, in particular calculated, relative to a point in the image representation, for example, relative to the zoom center at which the contrast value is maximum, using the dimensions and/or the imaging scale. For example, the tilt of the calibration object can be ascertained using a pose estimate. In addition, geometric deformations, for example, resulting trapezoids, occurring in the case of a tilt in a captured image representation of the calibration object, can be evaluated via a camera to determine the tilt. The described configuration has the advantage that the focus value at which the contrast value is maximum and the dependence between contrast value and focus value can be reliably determined easily and quickly.

At each of the at least two zoom positions, an image of the specified object can be captured at a multiplicity of focus values. The focus values can be adjusted via a settable focus system. In contrast to the variant described above, in which the different focus values are realized by the tilted arrangement of the calibration object in the image representation, the normal of the planar surface of the calibration object can enclose an angle of 0° with the optical axis. To this end, the surgical microscope must be equipped with an objective having a variable focal length. Via corresponding focusing, which can be automated, for each of the at least two zoom positions a value table and/or a curve can be ascertained which maps the contrast values as a function of the focus value. The focus value of the surgical microscope can be adapted using the contrast value curves. Alternatively, the calibration object can be moved along the optical axis.

In an advantageous variant, the focus value of the surgical microscope for each of the at least two zoom positions is adjusted and/or calibrated separately, that is, for each zoom position individually, so that the contrast value for each of the at least two zoom positions is maximum. Thus, in other words, when the zoom position is changed, the focus value is readjusted or reset, for example, via stored data, which are then permanently used during operation to set or correct the focus value accordingly. In addition or alternatively, in a further advantageous variant, the focus value of the surgical microscope for the at least two zoom positions can be adjusted and/or calibrated such that the difference between the focus values at which the contrast value is maximum for the at least two zoom positions is lower than a specified threshold value.

The focus value of the surgical microscope can be adjusted and/or calibrated in several ways. For example, the focus value of the surgical microscope can be adjusted and/or calibrated by adapting the distance between an object plane, for example a specified object, and the at least one objective, for example the first objective, for example a main objective, and/or the second objective, for example a video objective. In this variant, therefore, the focal distance is adapted by displacing at least one objective and/or an object relative to each other along an optical axis of the at least one objective.

In addition or as an alternative to the abovementioned first variant, the focus value of the surgical microscope can be adjusted and/or calibrated by adapting the distance between the objective, for example the first and/or the second objective, and an image plane of the image capture device. In this variant, therefore, the at least one objective and the image capture device are moved relative to each other in the direction of or along the optical axis of the objective, wherein the objective and/or the image capture device can be moved.

The at least one objective, that is, for example the first and/or second objective, may include a first optical element and a second optical element. In addition or as an alternative to the abovementioned two variants, the focus value of the surgical microscope can be adjusted and/or calibrated by displacing the first optical element of the objective with respect to the second optical element of the objective. An optical element is understood to mean a number of optical components that are positioned fixedly with respect to one another. For example, the optical element may include only one lens or a plurality of lenses. In the present variant, therefore, an inner focusing takes place in the respective objective, for example in a main objective or a video objective. In particular, the optical device may include a first objective, for example a main objective, and a second objective, for example a video objective, wherein the first objective is arranged in the beam path between an object plane and the second objective. For example, the focus value of the surgical microscope can be adjusted and/or calibrated by displacing the first optical element of the first objective with respect to the second optical element of the first objective and/or by displacing a first optical element of the second objective with respect to a second optical element of the second objective.

Advantageously, the zoom positions and/or the focus values are set automatically. This simplifies adjustment and/or calibration and reduces the time required for adjustment and/or calibration.

The surgical microscope may include a stereoscopic optical system, wherein the stereoscopic optical system has or defines a first optical path and at least one further optical path. At least one desired value and/or calibration data for the first optical path can be ascertained and transferred to the at least one further optical path. An optical path is understood to mean the path of light from an object through the optical system to an image plane. The described variant has the advantage that only one of a plurality of optical paths has to be adjusted and/or calibrated and the results of this process are immediately available for the at least one further optical path, so that the latter does not have to be adjusted and/or calibrated separately. This reduces the time required to adjust and/or calibrate the stereoscopic optical system.

The control device according to the disclosure for adjusting and/or calibrating and/or monitoring the focus value of a surgical microscope, which includes at least one objective, an image capture device and a zoom system, wherein the surgical microscope is configured to be operated in at least two different zoom positions, is configured to carry out a previously described method according to the disclosure. It has the features and advantages already described above.

The surgical microscope according to the disclosure includes at least one objective, an image capture device, for example a camera, in particular a video camera, and a zoom system. The surgical microscope is configured to be operated in at least two different zoom positions. The surgical microscope is also configured to carry out a method according to the disclosure, which is described above. The surgical microscope may include the control device according to the disclosure, which is described above. The surgical microscope according to the disclosure has the already described features and advantages. It preferably has a stereoscopic optical system.

The computer-implemented method according to the disclosure includes instructions which, when the program is executed by a computer, cause the latter to perform a method according to the disclosure, which is described above. The computer program product according to the disclosure includes instructions which, when the program is executed by a computer, cause the latter to perform a method according to the disclosure, which is described above. The computer program product according to the disclosure is stored on the computer-readable data carrier according to the disclosure. The data carrier signal according to the disclosure transmits the computer program product according to the disclosure. The computer-implemented method according to the disclosure, the computer program product according to the disclosure, the computer-readable data carrier according to the disclosure, and the data carrier signal according to the disclosure have the abovementioned features and advantages.

### BRIEF DESCRIPTION OF DRAWINGS

The invention will now be described with reference to the drawings wherein:

FIG. 1 schematically shows the beam path through a surgical microscope for two zoom positions;

FIG. 2 schematically shows a method according to the disclosure in the form of a flowchart;

FIG. 3 schematically shows contrast value curves as a function of the focus value for two zoom positions;

FIG. 4 schematically shows contrast value curves as a function of the focus value for four zoom positions;

FIG. 5 shows schematically a surgical microscope to be calibrated and a calibration object;

FIG. 6 shows schematically two images of the calibration object captured at different zoom positions;

FIG. 7 shows schematically in the form of a diagram a change in the focus value as a function of the zoom position for three different adjustment or calibration states;

FIG. 8 shows schematically a display of a contrast line (actual focus line) and a desired focus line in a captured image of a calibration object;

FIG. 9 schematically shows a first variant of a surgical microscope according to the disclosure with a control device according to the disclosure; and,

FIG. 10 schematically shows a second variant of a surgical microscope according to the disclosure with a control device according to the disclosure.

### DETAILED DESCRIPTION

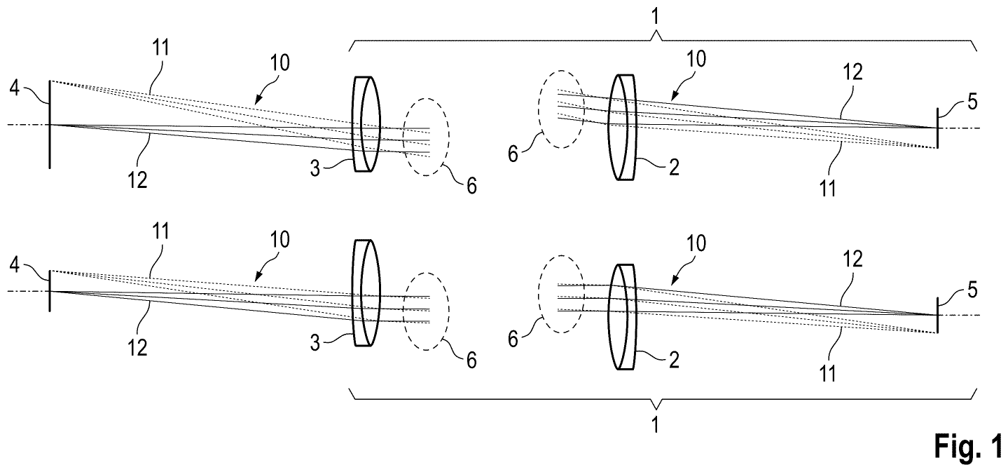

The background of the present disclosure is explained in more detail below with reference to FIG. 1. FIG. 1 schematically shows the beam path 10 through a surgical microscope 1 at two zoom positions. In the upper part of FIG. 1, a first zoom position with a low zoom value is set, and in the lower part of FIG. 1, a second zoom position with a high zoom value is set. The zoom value of the beam path shown in the upper part is therefore less than the zoom value of the beam path shown in the lower part.

The surgical microscope 1 includes a first objective 3 in the form of a main objective and a second objective 2 in the form of a video objective, each including at least one lens or a lens group. The second objective 2 is arranged in the beam path between the first objective 3 and an image capture device 5. In each case on the left of FIG. 1, the beam path 10 is shown upstream of the surgical microscope 1 and on the right downstream of the surgical microscope 1. The beam direction in FIG. 1 thus runs from left to right. Starting from an object plane 4, object points are imaged onto an image plane of an image capture device 5, for example on a camera chip. In the example shown, a first beam 11 and a second beam 12 each image an object point onto a camera chip 5. The beams 11 and 12 first pass through the first objective 3. The beam path downstream of the first objective 3 and upstream of the second objective 2 is afocal in each case. The region in which afocal radiation beams occur is in each case denoted by the reference sign 6. There is therefore a parallel beam path in the regions 6.

When adjusting and/or calibrating the surgical microscope 1, at least one lens, a set of lenses of the video objective 2 or the camera chip 5 is moved along the optical axis 7, that is, in the horizontal direction in FIG. 1. If the video objective 2 is correctly focused, as shown in FIG. 1, then the beam forming the axis beam, that is, in the present case the second beam 12, converges each independently of the zoom position at a point on the camera chip 5, thus not in front of or behind the camera chip 5.

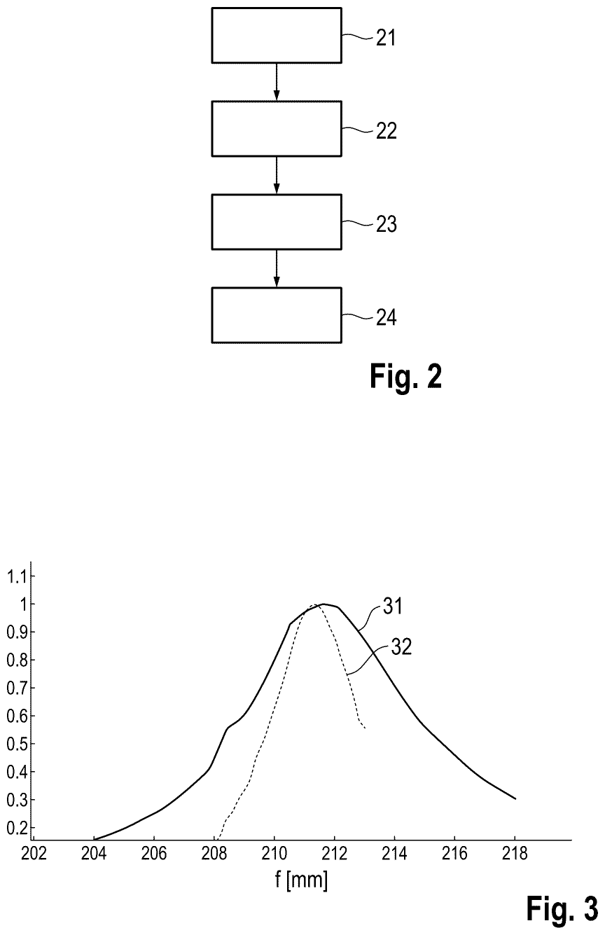

Examples of a method according to the disclosure for adjusting and/or calibrating the focus value of a surgical microscope are described in more detail below using FIGS. 2 to 6. The surgical microscope includes at least one objective, for example a first objective 3 in the form of a main objective and a second objective 2 in the form of a video objective, an image capture device 5 and a zoom system and is configured to be operated in at least two different zoom positions. The video objective 2 is arranged in the beam path 10 between the main objective 3 and the image capture device 5.

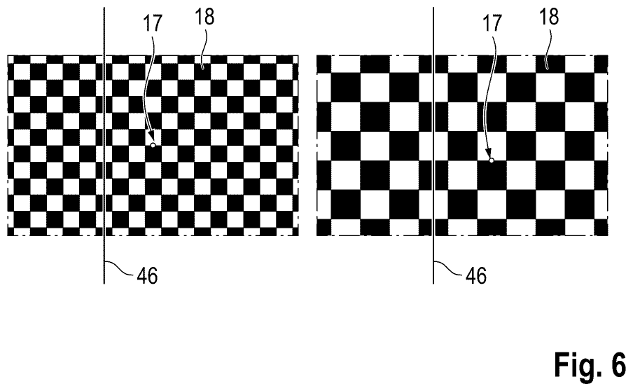

FIG. 2 schematically shows a method according to the disclosure in the form of a flowchart. In a first step 21, at least one image or an image representation of a specified object, preferably a known calibration object, is captured via the image capture device 5 in each case at least at two different zoom positions. In a second step 22, one or more contrast values are determined depending on the focus value via the at least one captured image. This is preferably done via suitable image evaluation software, which is configured, for example, to quantify black-and-white transitions of an image with regard to contrast. In a third step 23, at least one desired value and optionally a correction value for at least one parameter for adjusting and/or calibrating the focus value of the surgical microscope are ascertained via the determined contrast values for the at least two zoom positions. In this context, the focus value at which the contrast value for the respective zoom position is maximum can be ascertained. An example of the implementation of step 23 is explained in more detail below using FIGS. 6 to 8.

The ascertained focus values at which the contrast value for the respective zoom position is maximum can be used in an optional step 24 for adjusting and/or calibrating the surgical microscope, for example by adjusting and/or calibrating the surgical microscope in such a way that the focus position, in particular the focus position of the video objective 2, is adapted such that the maximum values of the contrast curves, that is, the maximum values of at least two contrast curves, appear at the same focus value or at a focus difference that is less than a specified threshold value. As soon as the desired focus difference is reached, the surgical microscope, in particular the video objective, is correctly adjusted and/or calibrated in the focus. With a focus difference of zero, the surgical microscope, in particular the objective, is tuned to infinity.

Alternatively, or in addition, in step 24, the ascertained focus values at which the contrast value for the respective zoom position is maximum can be stored for controlling the surgical microscope and used when using the individual zoom positions for adjusting and/or calibrating the focus value. For example, after installation and adjusting a surgical microscope, the contrast value curves for various zoom positions can be recorded and stored in the device. If the zoom setting is changed, a new actuating value for the focusing system can therefore be ascertained and set from the stored curves. This ensures a sharp image. Thus, only a rough adjustment is necessary or the adjustment may be superfluous under certain circumstances. This digital calibration can be done in the main objective, in the video objective, or by displacing the camera chip. A perfect adaptation of the magnification system to infinity is therefore no longer necessary. However, other image errors may occur, which can be corrected digitally.

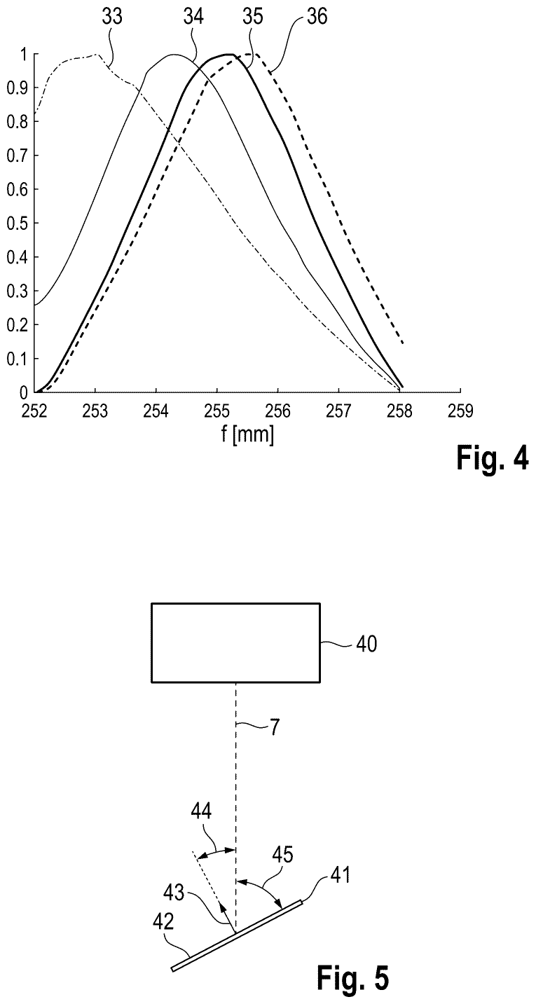

FIG. 3 schematically shows contrast value curves as a function of the focus value for two zoom positions. FIG. 4 schematically shows contrast value curves as a function of the focus value for four zoom positions. On the x-axis, the focus value f is in each case plotted in millimeters, and on the y-axis, the contrast value normalized to one is plotted. In FIG. 3, the contrast value curve 31 has been determined at a zoom position with a zoom value of 1.0 and has a maximum at a focus value of 211.6 mm. The contrast value curve 32 has been determined at a zoom position with a zoom value of 2.4 and has a maximum at a focus value of 211.4 mm. The focus values with a maximum contrast are relatively close together here, so that further adjustment and/or calibration can be omitted if appropriate. In FIG. 4, the contrast value curve 33 at a zoom position with a zoom value of 1.0, the contrast value curve 34 at a zoom position with a zoom value of 1.5, the contrast value curve 35 at a zoom position with a zoom value of 2.0, and the contrast value curve 36 at a zoom position with a zoom value of 2.4 have been determined. Here, the focus values with a maximum contrast are relatively far apart, so that an adjustment and/or calibration of the surgical microscope can be made using the contrast value curves.

There are various options for performing step 22, that is, for determining the plurality of contrast values depending on the focus value via a captured image. If the surgical microscope has a focus system, that is, the focus value can be set automatically, the curves shown in FIGS. 3 and 4 can be captured automatically. Focusing can therefore be automatic, and a respective image of a calibration object can be captured for individual focus values and evaluated in terms of contrast. If an automated zoom system is also available, the individual zoom settings can also be set automatically.

If the focus value is not automatically settable, the focus difference which results from two zoom positions with an obliquely positioned target as an object can be visually read or preferably ascertained by an image evaluation already described above. The focus value difference results in the necessary setting of the focus position of the optical device, in particular of a video objective. This variant is explained below on the basis of FIGS. 5 and 6.

FIG. 5 shows schematically a surgical microscope 40 to be adjusted and/or calibrated and a calibration object 41. The calibration object 41 can be fixedly connectable or connected to the surgical microscope 40.

The calibration object 41, which preferably has a planar surface 42 having a known pattern, preferably a ChArUco pattern, is arranged tilted with respect to the optical axis 7. In this case, a surface normal 43 of the surface 42 of the calibration object 41 may enclose an angle 44 of between 5 degrees and 85 degrees, for example 20 degrees, with the optical axis 7. This corresponds to an angle 45 of between 85 degrees and 5 degrees, for example 70 degrees, between the surface 42 and the optical axis 7. For a tilted calibration object 41, contrast values can be calculated for a plurality of focus values in an image.

Advantageously, the dimensions of the pattern, in particular the dimensions of elements of the pattern, are known or preset, or the dimensions are determined. The dimensions can be known or preset or determined in a unit of length, for example, millimeters. Preferably, the imaging scale, for example in the form of a relationship between the respective dimension of at least one element of the pattern in pixels and in a unit of length, is known or preset or is determined. If the tilt of the calibration object 41 is known or preset or set in a defined manner or ascertained, for example, via a pose estimate, the focus value at which the contrast value is maximum can be ascertained, in particular calculated, with the aid of the dimensions and/or the imaging scale. This configuration has the advantage that the focus value at which the contrast value is maximum and the dependence between contrast value and focus value can be reliably determined easily and quickly.

The variant with the tilted calibration object 41 also offers the advantage that optical systems, in particular surgical microscopes, with a fixed focal length can also be adjusted and/or calibrated. For this purpose, the contrast value curves for at least two zoom positions are first ascertained and then a desired focus position for at least one zoom position can be calculated and/or provided and/or displayed, so that the technician can adjust and/or calibrate the optical system using the displayed desired focus position (see FIG. 8 below, for example).

FIG. 6 shows schematically two images 18 of the calibration object 41 captured at different zoom positions. The zoom center is present and preferably placed in a point in the center of the image. If the zoom center is not in the center of the image, it is useful to place the coordinate origin of the object-side coordinate system used in the object point of the zoom center (projection of the zoom center into the object). In particular, the zoom center is the point in the captured image representations which does not move between the various magnification levels. The zoom center can be seen in particular as the optical center of an observer beam path. Camera systems are usually configured and/or adjusted such that the object point that is imaged onto the center of the camera chip does not move in the image representation during zooming. In this case, the optical axis defined by the zoom system will intersect the center of the camera chip. The calibration object 41 is tilted such that the focus value in FIG. 6 changes from left to right. The image shown on the left was captured at a first zoom position and the image shown on the right was captured at a second zoom position. The contrast lines, that is, vertical lines with the highest contrast in the images shown, are denoted with the reference sign 46. The contrast line 46 at the second zoom position, that is, in the depiction shown on the right in FIG. 6, appears in the image relative to an object marking 17 on the calibration object 41 further to the right of the calibration object 41 than the contrast line 46 at the first zoom position shown on the left in FIG. 6. In other words, the contrast line 46 is about three checkerboard patterns (white or black square) to the left of the object marking 17 in the depiction shown on the left in FIG. 6 and about two checkerboard patterns to the left of the object marking 17 in the depiction shown on the right in FIG. 6. The contrast line 46 thus shifts relative to the calibration object 41 or to the object marking 17. This means that the focus plane moves, or in other words migrates, along the optical axis 7 when switching between the two zoom positions. If the contrast line 46 were always at the same location of the object, the focus value difference would be zero. The object marking 17 can be placed anywhere on the object. The relative change or migration of the contrast line 46 would remain the same. However, it is preferable to select an object point which coincides with the zoom center and thus with the optical axis of the zoom system.

The conversion of the horizontal displacement of the contrast line 46 from the first zoom position (see left depiction of FIG. 6) to the second zoom position (see right depiction of FIG. 6) at the calibration object 41 to a vertical difference, that is, a difference in the direction of the optical axis 7, corresponds to the focus value difference. This focus value difference can be calculated from the displacement of the contrast line 46, the geometry of the experimental arrangement and a scale, for example the size of the ChArUco markings of the pattern on the planar surface 42 of the calibration object 41. Typically, the focus plane is a sphere, so the contrast line 46 shown represents an approximation of a contrast curve. If the curvature of the contrast curve, that is, the deviation of the shown contrast line 46 (straight line) from the actual contrast curve, is small, an approximation as a line is justified. Otherwise, the actual contrast curves must be taken into account.

In all variants it is advantageous to use a known calibration object, for example a checkerboard or a ChArUco board. This simplifies the detection and evaluation of contrast.

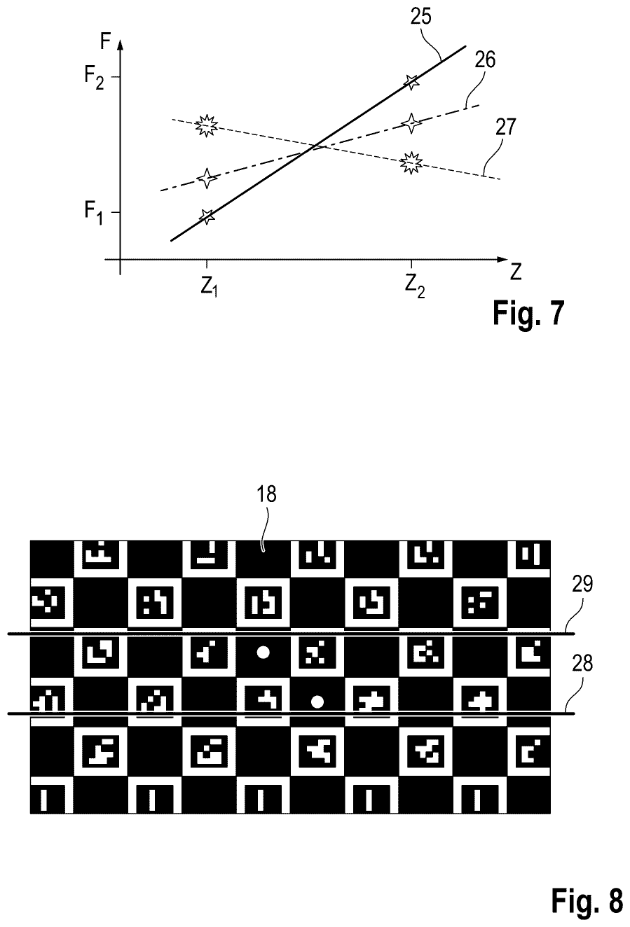

The change in the contrast line shown in FIG. 6 indicates a migration of or a change in the focus value depending on the zoom position. This is shown schematically in FIG. 7 in the form of a diagram. The zoom position Z is plotted on the x-axis, and the focus value F is plotted on the y-axis. The focus value can be specified in millimeters or in pixels or in any unit which characterizes the migration of the focus with respect to the calibration object 41, for example, the migration with respect to an object marking 17 on the calibration object 41. The dimension of a geometric shape or structure, which is imaged on the calibration object 41, can be used as a scale. In the example shown in FIG. 6, for example, the width of one of the imaged rectangles can be used as a scale. Since the procedure according to the disclosure explained in detail below only requires relative focus values, that is, deviations of the determined focus values from a reference point or from one another, the present disclosure has the advantage that an adjustment and/or calibration can be carried out with any calibration object 41. Therefore, no measured calibration object is required.

FIG. 7 shows the results for three measurements. By way of example, the focus value F was determined for a zoom position Z₁ and a zoom position Z₂. The focus values F are preferably determined for more than two zoom positions Z. A function of the focus value can be determined from the measurement values depending on the zoom position F=f(Z). This can preferably be assumed to be a straight line with a gradient g (F^{˜}g*Z). The migration of the focus value in relation to the calibration object is represented by the gradient g. The absolute value of the gradient g should be minimized in the adjustment and/or calibration and preferably approach zero or are set to near zero. In other words, the straight line should preferably run parallel to the x-axis in the result of the adjustment and/or calibration.

In FIG. 7, a focus value of F₁ determined during a first measurement at the zoom value Z₁ and a focus value of F₂ at the zoom value Z₂ and a straight line 25 with the gradient g=(F₂−F₁)/(Z₂−Z₁) was determined therefrom. The focus value of the surgical microscope was then increased or decreased by ΔF and a second measurement was performed in the same way as the first measurement. Increasing or decreasing can be done at any zoom position. Here, the straight line 26 which has a lower gradient than the straight line 25 was ascertained. The focus value of the surgical microscope was then increased or decreased further, and a third measurement was performed in the same way as the first two measurements. In this case, the straight line 27 which has a negative gradient was ascertained.

Based on the dependence, thus ascertained, between a change in the focus value ΔF of the surgical microscope and the gradient g(g=f(ΔF)), the focus value of the surgical microscope can be adjusted or calibrated in such a way that a gradient g of zero or, taking into account a predetermined tolerance, close to zero is obtained. It has been found that there is usually a zoom-independent linear dependency (g^{˜}m*(ΔF), where m indicates the increase), so that two measurements, for example, a first measurement with a tilted calibration object at a first zoom position and a second measurement with the tilted calibration object at a second zoom position, are sufficient in principle to ascertain a desired value or target value for adjustment and/or calibration, in particular a value by which the current focus value of the surgical microscope must be increased or decreased to change the absolute value of the gradient g as intended. Thus, on the one hand, the dependence of a change in the focus value ΔF of the surgical microscope and the gradient g in the context of methods according to the disclosure, as described, can be ascertained or assumed to be known. In the latter case, the surgical microscope can be adjusted and/or calibrated on the basis of a determination of only one gradient. The required change in the focus value can be specified, for example in millimeters.

In connection with the adjustment and/or calibration, the ascertained desired value or target value can be displayed to a technician, for example, in the form of a tolerance bar, tolerance strip, a line or curve, which in particular runs parallel to the ascertained contrast curve or contrast line 46. FIG. 8 shows this schematically. In the example shown, the calibration object 41 is tilted in such a way that the focus changes from top to bottom. In FIG. 8, in a captured image 18 of a calibration object 41, a desired line is denoted with the reference sign 29 and the line with the currently highest contrast, that is, the current contrast line, is denoted with the reference sign 28.

There are various options for adjusting and/or calibrating the focus value of the surgical microscope 1 for individual or all zoom positions, which can be applied individually or in combination with one another. A first variant is to change the focal distance, that is, the distance between the object or object plane 4 and at least one of the objectives 2, 3. In the case of a surgical microscope 1, which includes a main objective 3 and a video objective 2, the main objective 3 in this case can be moved relative to the object or the object plane 4. A second variant is to change the distance between the objective 2 and the image plane 5 of the surgical microscope 1. In this case, the image capture device 5, that is, for example the camera or a camera chip, or the second objective 2 can be moved, that is, displaced relative to each other.

A third variant includes using an objective 2, 3, which allows inner focusing, which thus includes at least one first optical element and at least one second optical element, wherein the first optical element and the second optical element are displaceable relative to each other. This means that at least one of the optical elements can be displaced, while the other optical element is fixed. In the case of a surgical microscope, the main objective 3 may be configured as an objective with a variable focal length. In addition or alternatively, the video objective 2 can allow appropriate inner focusing.

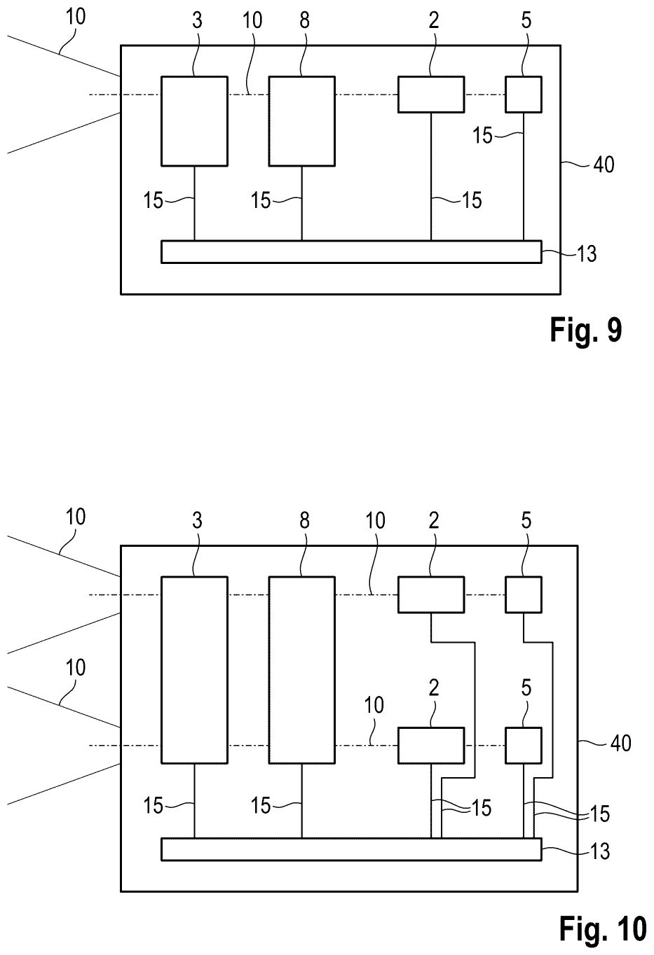

FIG. 9 shows schematically a first variant of a surgical microscope 40 according to the disclosure. The surgical microscope 40 includes a control device 13 according to the disclosure, which is configured to carry out a method according to the disclosure, for example a variant of a method described previously with reference to FIGS. 2 to 8. The surgical microscope 40 shown includes a first objective 2, for example in the form of a video objective 2, a second objective 3, for example in the form of a main objective 3, a zoom system 8 for changing the zoom position, and an image capture device 5, for example a camera 5. The first objective 2 and/or the second objective 3 may be configured as objectives with variable focal lengths, thus each including at least two lenses or lens groups which are displaceable relative to each other.

The first objective 3, the zoom system 8, the second objective 2 and the image capture device 5 are optically connected to one another in the order mentioned, that is, arranged in succession in a beam path 10. The control device 13 is connected to the aforementioned components 2, 3, 5 and 8 for signal transmission 15 and controls in particular the zoom system 8.

FIG. 10 schematically shows a second variant of a surgical microscope 40 according to the disclosure in a stereoscopic construction. In contrast to the variant shown in FIG. 9, in each case two video objectives 2 and image capture devices 5, in particular camera chips, arranged parallel to one another in the beam path 10, are present. The zoom system 8 can have its own optical elements for the respective beam paths, that is, a first and a second optical path (separate beam paths or optical paths). The same and synchronous displacement of the lenses can be achieved by mechanical, electronic or electro-mechanical coupling. In the context of the method according to the disclosure, at least one desired value and/or calibration data for the first optical path can be ascertained and transferred to the second optical path.

If a calibration (for example, in the form of a camera matrix and/or distortion coefficients) of a stereoscopic system is present, a topography can be created during operation. A plane or sphere of the topography will have the highest contrast and will intersect the topography. This contrast evaluation can be performed in one camera image and/or both camera images. The points in the image representation having the highest contrast can be shown with a free curve in the camera image. If the focus value of the surgical microscope is set correctly, this free curve will migrate with the object in the camera image when the zoom setting is changed. This focus migration can then be calculated as a function of the zoom (gradient of the straight line in FIG. 7). If this is not the case, or if the relative migration at the topography is too large, the service technician could be notified for readjustment purposes and/or the user could be informed. Alternatively, the user could be requested to carry out this monitoring at regular intervals. This method therefore also enables monitoring of the focus value in the field.

It is understood that the foregoing description is that of the preferred embodiments of the invention and that various changes and modifications may be made thereto without departing from the spirit and scope of the invention as defined in the appended claims.

### LIST OF REFERENCE SIGNS

1 Surgical microscope
2 Second objective, video objective
3 First objective, main objective
4 Object plane
5 Image capture device, camera chip, image plane
6 Afocal beams
7 Optical axis
8 Zoom system
10 Beam path
11 First beam
12 Second beam
13 Control device
15 Signal transmission
17 Object marking
18 Captured image of a surface of a calibration object
21 Capturing at least one respective image of a specified object with at least two different zoom positions
22 Determining one or more contrast values depending on the focus value via the at least one captured image
23 Ascertaining at least one desired value for at least one parameter for adjusting and/or calibrating the focus value using the determined contrast values for the at least two zoom positions
24 Adjusting and/or calibrating the surgical microscope
25 First measurement
26 Second measurement
27 Third measurement
28 Actual focus line
29 Target focus line
31 Contrast value curve
32 Contrast value curve
33 Contrast value curve
34 Contrast value curve
35 Contrast value curve
36 Contrast value curve
40 Surgical microscope
41 Calibration object
42 Planar surface
43 Surface normal
44 Angle
45 Angle
46 Contrast line
f Focus

1. A method for performing at least one of adjusting, calibrating and monitoring a focus value of a surgical microscope including at least one objective, an image capture device and a zoom system, wherein the surgical microscope is configured to be operated in at least two different zoom positions, the method comprising:
for at least two different zoom positions, capturing at least one image of a specified object via the image capture device;
via the at least one captured image, determining a plurality of contrast values depending on the focus value; and,
via the determined contrast values for the at least two zoom positions, ascertaining at least one desired value for at least one of the following:
i) at least one parameter for adjusting the focus value of the surgical microscope; and,
ii) at least one parameter for calibrating the focus value of the surgical microscope.

2. The method of claim 1, wherein at least one correction value for the relative position of the at least one objective and/or the image capture device within the surgical microscope with respect to the beam path is ascertained based on the at least one desired value.

3. The method of claim 1, wherein at least one of the following applies:
i) the at least one desired value for each of the at least two zoom positions is ascertained and/or specified separately; and,
ii) the at least one desired value for the at least two zoom positions is ascertained and/or specified in a way such that the difference between the focus values at which the contrast value is maximum is less for the at least two zoom positions than a specified threshold value.

4. The method of claim 1, wherein the objective defines an optical axis; and the method further comprising: as part of the capture of at least one image of a specified object, capturing at least one image of a planar surface of the specified object; and, wherein, the planar surface has a surface normal which encloses with the optical axis of the objective an angle of between 5 degrees and 85 degrees.

5. The method of claim 1, wherein, for each of the at least two zoom positions, an image of the specified object is captured at a plurality of focus values.

6. The method of claim 5, wherein the focus values are set using an adjustable focus system.

7. The method of claim 1, wherein at least one of the following applies:
i) the focus value of the surgical microscope for each of the at least two zoom positions is adjusted and/or calibrated separately such that the contrast value for each of the at least two zoom positions is maximum; and,
ii) the focus value of the surgical microscope for the at least two zoom positions is adjusted and/or calibrated such that the difference between the focus values at which the contrast value is maximum is less for the at least two zoom positions than a specified threshold value.

8. The method of claim 1, wherein the focus value of the surgical microscope is adjusted and/or calibrated by at least one of the following:
i) adapting the distance between an object plane and the objective at least one of the following applies:
ii) adapting the distance between the objective and an image plane of the image capture device; and,
iii) by displacing a first optical element of the at least one objective relative to a second optical element of the at least one objective.

9. The method of claim 1, wherein at least one of the following applies: i) the zoom positions are set automatically; and, (ii) the focus values are set automatically.

10. The method of claim 1, wherein at least one of the following applies:
i) at the at least two different zoom positions, in each case at least one image of a specified calibration object, which has known features, is captured such that high-contrast regions are recognizable in the image representation; and,
ii) only contrast values in a specified region of the image center are determined and/or evaluated.

11. The method of claim 1, wherein the surgical microscope has a stereoscopic optical system, wherein the stereoscopic optical system has a first optical path and at least one further optical path and at least one desired value and/or calibration data for the first optical path is ascertained and transferred to the at least one further optical path.

12. The method of claim 1, wherein the focus value is a relative focus value or a focus value difference.

13. The method of claim 1, wherein the ascertainment of the desired value includes ascertaining a change value of the focus of the surgical microscope, wherein the ascertainment of the desired value and/or the change value is based on an evaluation of the gradient of at least one curve which maps the dependence of the focus value or a captured focus change with respect to a reference variable from the zoom position, wherein a functional relationship between the gradient and a focus setting of the surgical microscope is used.

14. The method of claim 1, wherein the desired value is calculated and/or provided in the form of a target focus line or target focus region in a captured image of the specified object.

15. A control device for carrying out at least one of the following: adjusting, calibrating and monitoring a focus value of a surgical microscope including at least one objective, an image capture device and a zoom system, wherein the surgical microscope is configured to be operated in at least two different zoom positions; the control device comprising being configured to carry out a method including the steps of:
for at least two different zoom positions, capturing at least one image of a specified object via the image capture device;
via the at least one captured image, determining a plurality of contrast values depending on the focus value; and,
via the determined contrast values for the at least two zoom positions, ascertaining at least one desired value for at least one of the following:
i) at least one parameter for adjusting the focus value of the surgical microscope; and,
ii) at least one parameter for calibrating the focus value of the surgical microscope.

16. A surgical microscope comprising at least one objective, an image capture device and a zoom system, wherein the surgical microscope is configured to be operated in at least two different zoom positions; and,
the surgical microscope is configured to carry out a method including the steps of:
for at least two different zoom positions, capturing at least one image of a specified object via the image capture device;
via the at least one captured image, determining a plurality of contrast values depending on the focus value; and,
via the determined contrast values for the at least two zoom positions, ascertaining at least one desired value for at least one of the following:
i) at least one parameter for adjusting the focus value of the surgical microscope; and,
ii) at least one parameter for calibrating the focus value of the surgical microscope.

17. The surgical microscope of claim 16, further comprising a controller configured to carry out said method steps.

18. The surgical microscope of claim 16, wherein the surgical microscope has a stereoscopic optical system.

19. A computer-implemented method comprising instructions which, when the program is executed by a computer, cause the latter to carry out a method for performing at least one of adjusting, calibrating and monitoring a focus value of a surgical microscope including at least one objective, an image capture device and a zoom system, wherein the surgical microscope is configured to be operated in at least two different zoom positions, the method comprising the steps of:
for at least two different zoom positions, capturing at least one image of a specified object via the image capture device;
via the at least one captured image, determining a plurality of contrast values depending on the focus value; and,
via the determined contrast values for the at least two zoom positions, ascertaining at least one desired value for at least one of the following:
i) at least one parameter for adjusting the focus value of the surgical microscope; and,
ii) at least one parameter for calibrating the focus value of the surgical microscope.
